(19) United States
(12) Patent Application Publication
(10) Pub. No.: US 2008/0291226 A1
(43) Pub. Date: Nov. 27, 2008

(54) RECORDING METHOD AND RECORDING DEVICE

(75) Inventors: Kohei Ishikawa, Tokyo (JP); Tadashi Saito, Kawasaki-shi (JP); Noritaka Nakashima, Nagareyama-shi (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 12/024,591

(22) Filed: Feb. 1, 2008

(30) Foreign Application Priority Data
Feb. 9, 2007 (JP) 2007-030371

(51) Int. Cl. G01D 9/00

(52) U.S. Cl. 346/33 R

(57) ABSTRACT

For use when the recordable area of a recording medium is smaller than recording data, there is provided a recording device that can determine the priority of divided areas and preferentially record a high-priority area. The recording device assigns priority to each of the recording areas of a whole image on one page and, if it is determined that the whole image does not fit on the recording medium, performs at least one of rearranging the recording position of a high-priority area, changing the recording size of a low-priority area, and discarding a part of recording data of the low-priority area based on the priority of the recording areas to prevent any part of the image of the high-priority area from being lost.

### DETAILED DESCRIPTION

1. Field of the Invention

The present invention relates to a recording method and a recording device that expand image recording data into a print buffer and record the expanded data.

2. Related Art

Conventionally, a recording device is proposed that divides the whole image of one recording page into plural areas, assigns priority to each of the divided areas, and changes the error or warning processing method by determining the priority of recording data in one page (Japanese Patent Laid-Open Publication No. 2006-43897). This recording device has a function that does not generate an error if a high-priority area is recorded normally (even if a low-priority recording area is be not recorded) when the recordable area on a recording medium is smaller than given recording data.

Another print data processing device is proposed that determines if print data fits in the recording range on a recording medium and, if not, automatically increases or decreases the print data size and outputs the print data (Japanese Patent Laid-Open Publication No. 1993-127849).

One of the problems with the conventional recording device described above is that, when the recordable area on a recording medium is smaller than given recording data, the recording data is recorded without being changed even if the high-priority area of the divided areas cannot be recorded.

Another problem with the conventional print data processing device described above is that, when the recordable area on a recording medium is smaller than given recording data and the recording data is automatically reduced in its entirety, important information, information not to be reduced, or information such as a bar code that, if reduced, may cause a problem at a read time is also reduced unconditionally.

### SUMMARY OF THE INVENTION

In view of the foregoing, it is an object of the present invention to provide a recording method and a recording device that determine the priority of each of the divided areas and record a high-priority area in its entirety without reducing its size when the recordable area on a recording medium is smaller than given recording data.

A recording method according to the present invention is a recording method for recording an image on a recording medium. The recording method comprises the steps of acquiring a size of a recording area of a whole image on one page as a page size; detecting a size of a recording medium as a recording medium size; dividing the whole image on one page into a plurality of areas having respective priorities; determining based on the page size and the recording medium size if the whole image fits on the recording medium; and if it is determined that the whole image does not fit on the recording medium, performing at least one of rearranging a recording position of a high-priority area, changing a recording size of a low-priority area, and discarding a part of recording data of the low-priority area, to prevent any part of an image of the high-priority area from being lost. Note that the changing a recording size of a low-priority area includes a case in which the recording size is changed by discarding a part of an image in the area and a case in which the recording size is changed by reducing the size of an image in the area.

In a first embodiment of the present invention, the whole image on one page is divided into the plurality of areas, high priority is assigned to a particular area and, if it is determined before recording the one page that a part of recording data in the high-priority area will be lost, a part of recording data of the low-priority area is discarded for recording to prevent any part of recording data of the high-priority area from being lost.

In a second embodiment of the present invention, the whole image on one page is divided into the plurality of areas, high priority is assigned to a particular area and, if it is determined before recording the one page that a part of recording data in the high-priority area will be lost, the high-priority area is exchanged with the low-priority area for recording to prevent any part of recording data of the high-priority area from being lost.

In a third embodiment of the present invention, the whole image on one page is divided into the plurality of areas, high priority is assigned to a particular area and, if it is determined before recording the one page that a part of recording data in the high-priority area will be lost, the recording data of the low-priority area is reduced in size for recording to prevent any part of recording data of the high-priority area from being lost.

In any of the recording methods, if it is determined that recording data will be recorded with a part of the high-priority area lost, the high-priority area is recorded in its entirety, with neither a loss nor a reduction in size, at the sacrifice of the recording of the low-priority area.

A recording device according to the present invention comprises a page size acquisition unit that acquires a size of a recording area of a whole image on one page as a page size; a recording medium size detection unit that detects a size of a recording medium as a recording medium size; an area division unit that divides the whole image on one page into a plurality of areas having respective priorities; and a recording unit that determines if the whole image fits on the recording medium based on the page size and the recording medium size and, if it is determined that the whole image does not fit on the recording medium, performs at least one of rearranging a recording position of a high-priority area, changing a recording size of a low-priority area, and discarding a part of recording data of the low-priority area, to prevent any part of an image of the high-priority area from being lost.

When margins are set at sides of a recording medium, the margin must be taken into consideration to determine if the whole image fits on the recording medium.

As will be described below, the present invention also provides recording devices that correspond to the recording methods described above.

The effect of those recording devices is the same as that of the recording method described above.

According to the present invention, when the recordable area on a recording medium is smaller than recording data, the whole of a high-priority area is preferentially recorded without reducing its size by determining the priority of the areas on one page, thus reducing errors and providing a high-production recording method and a high-production recording device.

### BRIEF DESCRIPTION OF THE DRAWINGS

FIG. 1 is a diagram showing the general configuration of a recording system in an embodiment of the present invention.

FIG. 2 is a block diagram showing the general configuration of a PC used in the embodiment of the present invention.

FIG. 3 is a diagram showing the external configuration of an operation panel of a recording device used in the embodiment of the present invention.

FIG. 4 is a cross section diagram showing the general configuration of the recording device used in the embodiment of the present invention.

FIGS. 5A-5C are diagrams showing the structure of control commands used in the embodiment of the present invention.

FIG. 6 is a simplified block diagram related to the electrical control in the recording device in the embodiment of the present invention.

FIG. 7 is a diagram showing an example of recording on a recording medium on the recording device in the embodiment of the present invention.

FIG. 8 is a diagram showing the memory map of a RAM in the recording device in the embodiment of the present invention.

FIG. 9 is a flowchart showing the flow of processing performed by a recording data creation application software program on the PC in the embodiment of the present invention.

FIG. 10 is a flowchart showing the flow of recording job control processing in the recording device in the embodiment of the present invention.

FIG. 11 is a flowchart showing the flow of paper feed processing in the recording device in the embodiment of the present invention.

FIG. 12 is a flowchart showing the flow of recording processing in the recording device in the embodiment of the present invention.

FIG. 13 is a diagram showing an example of recording on a recording medium in which the position of a high-priority area and the position of a low-priority area are exchanged in the recording device in the embodiment of the present invention.

FIG. 14 is a diagram showing the general configuration of a recording system in a second embodiment of the present invention.

FIG. 15 is a cross section diagram showing the general mechanical configuration of the internal of a recording device used in the second embodiment of the present invention.

FIG. 16 is a diagram showing the structure of control commands used in the second embodiment of the present invention.

FIG. 17 is a simplified electrical block diagram of the recording device in the second embodiment of the present invention.

FIG. 18 is a diagram showing an example of recording on a recording medium on the recording device in the second embodiment of the present invention.

FIG. 19 is a diagram showing the internal configuration of a flash ROM (FIG. 17) in the recording device in the second embodiment of the present invention.

FIG. 20 is a diagram showing the memory map of a RAM (FIG. 17) in the recording device in the second embodiment of the present invention.

FIG. 21 is a flowchart showing the flow of a recording data creation application software program on a PC in the second embodiment of the present invention.

FIG. 22 is a flowchart showing the flow of recording job control processing in the recording device in the second embodiment of the present invention.

FIG. 23 is a flowchart showing the flow of recording processing (1) in the second embodiment of the present invention.

FIG. 24 is a flowchart showing the flow of recording processing (2) in the second embodiment of the present invention.

FIG. 25 is a flowchart showing the flow of recording result confirmation processing in the second embodiment of the present invention.

FIG. 26 is a diagram showing an example of a recording medium on which a high-priority area is recorded with the recording of a low-priority area interrupted on the recording device in the second embodiment of the present invention.

FIGS. 27A and 27B are diagrams showing an example of a recording medium on which all recording areas are normally recorded, and an example of recording medium on which all areas cannot be recorded because the recording medium is too small, on a recording device in a third embodiment of the present invention.

FIGS. 28A and 28B are diagrams showing an example of a recording medium on which all recording data is normally recorded, and an example of a recording medium on which all recording data cannot be recorded because the recording medium is too small, on a recording device in a fourth embodiment of the present invention.

FIG. 29 is a diagram showing an example of a recording medium on which the positions of a high-priority area and a low-priority area are exchanged, and the low-priority area is automatically reduced, for recording on a recording device in a fifth embodiment of the present invention.

### DETAILED DESCRIPTION OF PREFERRED EMBODIMENTS

Preferred embodiments of the present invention will be described in detail below with reference to the drawings.

### First Embodiment

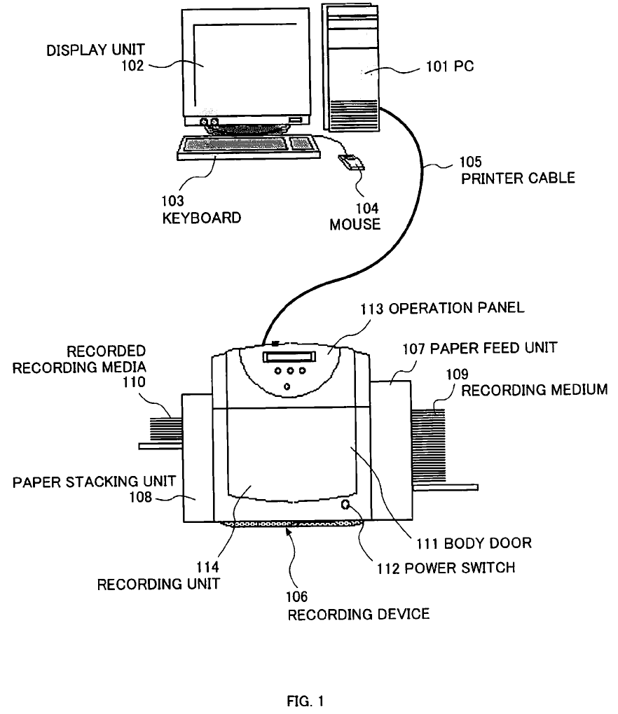

FIG. 1 is a diagram showing the general configuration of a recording system in this embodiment in which a card recording device (hereinafter called a recording device), which uses an inkjet line recording head (hereinafter called a recording head), and a personal computer (hereinafter called a PC) are connected.

A recording device 106 has, on its front, an operation panel 113 that is used for the operation and the display, a power switch 112 that controls the on/off of the power supply, and a body door 111 that is opened and closed when maintenance work is required to exchange an ink tank or to remove a recording medium jam. Recording media 109, which are recording media cut to a predetermined size, are set in a paper feed unit 107, and recorded recording media 110 are stacked in a paper stacking unit 108.

A PC 101 and the recording device 106 are connected by a printer cable 105, and the recording device 106 receives a control command from the PC 101 via the printer cable 105 and processes the received control command.

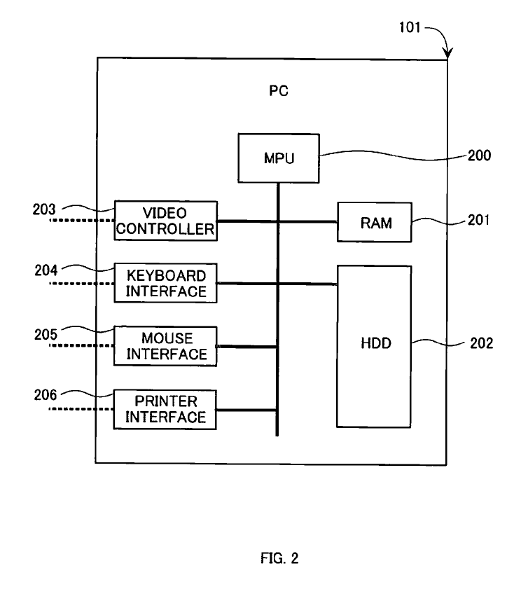

FIG. 2 is a block diagram showing the general configuration of the PC 101 used in this embodiment.

The PC 101 is connected to a keyboard 103 and a mouse 104, which are input devices, by the bus via a keyboard interface 204 and a mouse interface 205 respectively, to the recording device 106 via a printer interface 206, and to a display unit 102, which is a display device such as a CRT and an LCD, via a video controller 203.

The PC 101 causes an MPU 200 to execute a recording data creation application software program stored on a hard disk drive (HDD) 202. By doing so, the CPU 101 performs various types of processing including processing for creating recording data and processing for converting recording information, stored in a RAM 201, to a control command and outputting the generated control command to the printer cable 105 via the printer interface 206.

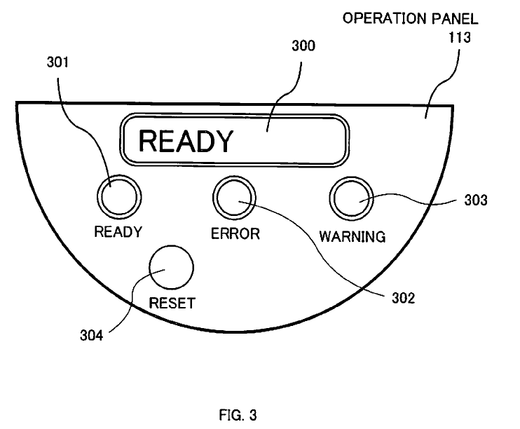

FIG. 3 is a diagram showing the external configuration of the operation panel 113 of the recording device used in this embodiment.

On the operation panel 113, there are provided an Error LED 302 that is a light-emitting unit for notifying the generation of an error, a Warning LED 303 that notifies the generation of a warning, a Ready LED 301 that notifies the power-on state, a Reset key 304 used to release an error, and a liquid crystal display unit (LCD) 300 that displays the status of the recording device.

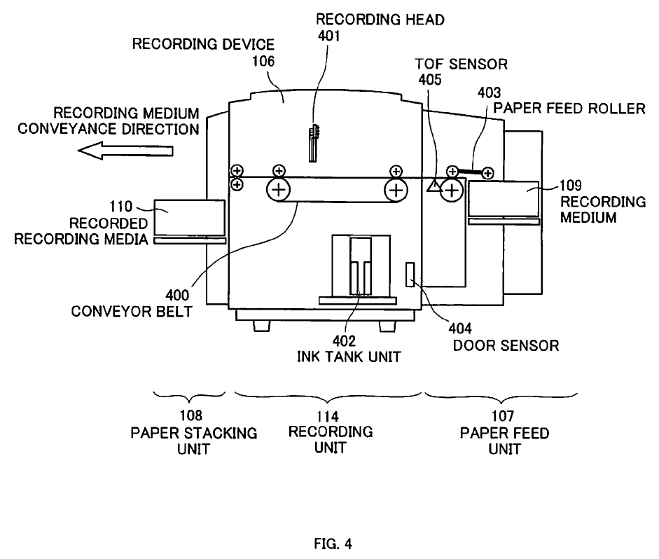

FIG. 4 is a cross section diagram showing the general configuration of the recording device 106 used in this embodiment.

The recording device 106 roughly comprises the paper feed unit 107, a recording unit 114, and the paper stacking unit 108.

The paper feed unit 107 feeds the recording medium 109 to the recording unit 114 via a paper feed roller 403 that is rotated by a paper feed motor (not shown). The paper feed unit 107 also has a TOF (Top Of Form) sensor 405 that detects the recording medium size and the recording medium position.

The recording unit 114 comprises a conveyor belt 400 that conveys the recording medium 109, a recording head 401 from which ink is ejected, an ink tank unit 402 that supplies ink to the recording head 401, and a door sensor 404 that senses the opening/closing of the body door.

The ink tank unit 402, connected to the recording head 401 via a tube (not shown), controls a recovery motor 608, which will be described below, to supply ink to the recording head 401.

At recording time, the leading edge position of the conveyed recording medium 109 is sensed by the TOF sensor 405 and, based on the sensed position information, ink is ejected from the recording head 401 according to the image formation signal to form an image with the ink ejected onto the surface of the recording medium.

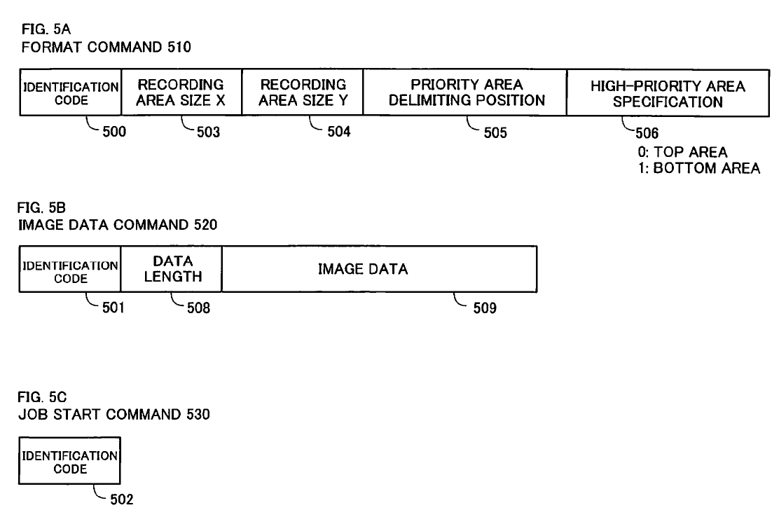

FIGS. 5A-5C show the structures of the control commands used in this embodiment.

Three types of control commands are provided: format command 510, image data command 520, and job start command 530. The PC 101 outputs those commands to the printer cable 105 via the printer interface 206.

The format command 510 shown in FIG. 5A specifies an identification code 500 that identifies the command, a recording area size X 503 that specifies the X direction size of the recording area, a recording area size Y 504 that specifies the Y direction size of the recording area, a priority area delimiting position 505 that indicates the position delimiting between a high-priority area and a low-priority area, and a high-priority area specification 506 that specifies which area is a high-priority area. Note that the X direction is the direction orthogonal to the recording medium conveyance direction, and the Y direction is the same as the recording medium conveyance direction. In this embodiment, recording data is divided into two areas, top area and bottom area, for each of which two stages of priority, high-priority area/low-priority area, can be specified. A high-priority area specification 506 being “0” indicates that the leading edge side (downstream side in the recording medium conveyance direction) of the position delimited by the priority area delimiting position 505 is a high-priority area, while the high-priority area specification 506 being “1” indicates that the trailing edge side of the position delimited by the priority area delimiting position 505 is a high-priority area.

The image data command 520 shown in FIG. 5B is a command that defines the image of a print object. This command includes an identification code 501, image data 509 that will be expanded into the print buffer, and its data length 508.

The job start command 530 shown in FIG. 5C is a command that indicates the end of recording data to the recording device 106 and starts a job.

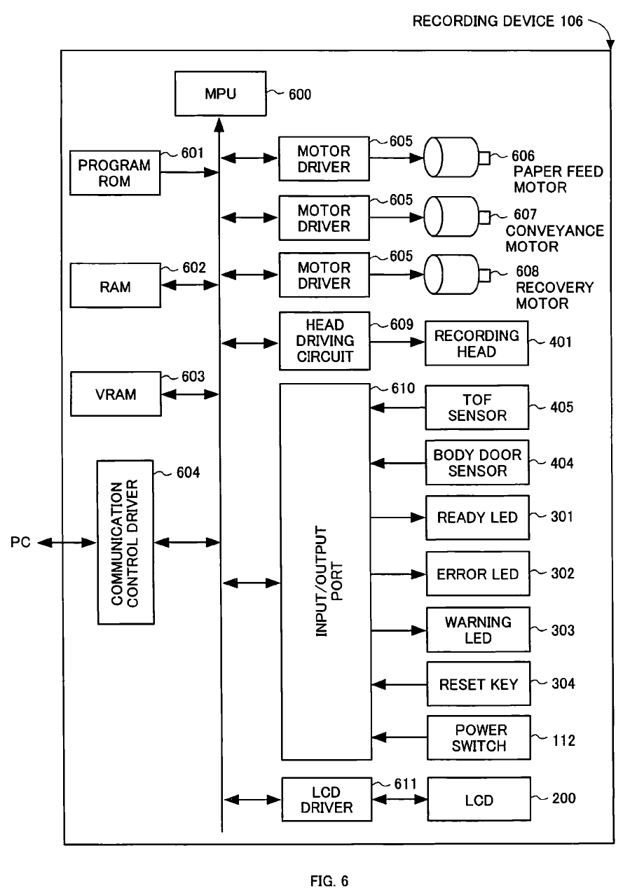

FIG. 6 is a simplified block diagram related to the electrical control of the recording device 106 in this embodiment.

A microprocessor (MPU) 600 performs the following control operation by executing the control program stored in a program ROM 601.

(1) Receives a control command from the PC 101 under control of a communication control driver 604.
(2) Performs the following operation according to the received control command: stores the parameters into a RAM 602 if the command is the format command 510, expands the image data into a VRAM 603, which is a print buffer, if the command is the image data command 520, and starts the recording operation if the received command is the job start command 530.
(3) Controls a motor driver 605 to drive a paper feed motor 606, a conveyor motor 607, and the recovery motor 608.
(4) Controls the on/off (turn on/turn off) of the Error LED 302, Ready LED 301, and Warning LED 303 via an input/output port 610 according to the status of the recording device and control an LCD driver 611 to display a message on the LCD 300.
(5) Periodically monitors the input from the Reset key 304, the power switch 112, and the body door 111 via the input/output port 610.
(6) Controls the input/output port 610 to detect the recording medium size with the use of the TOF sensor 405 and, in synchronization with the recording medium position information relative to the leading position of the detected recording medium, controls a head driving circuit 609 to drive the recording head 401 for proper ink ejection, and records on the recording medium according to the image data expanded in the VRAM 603.

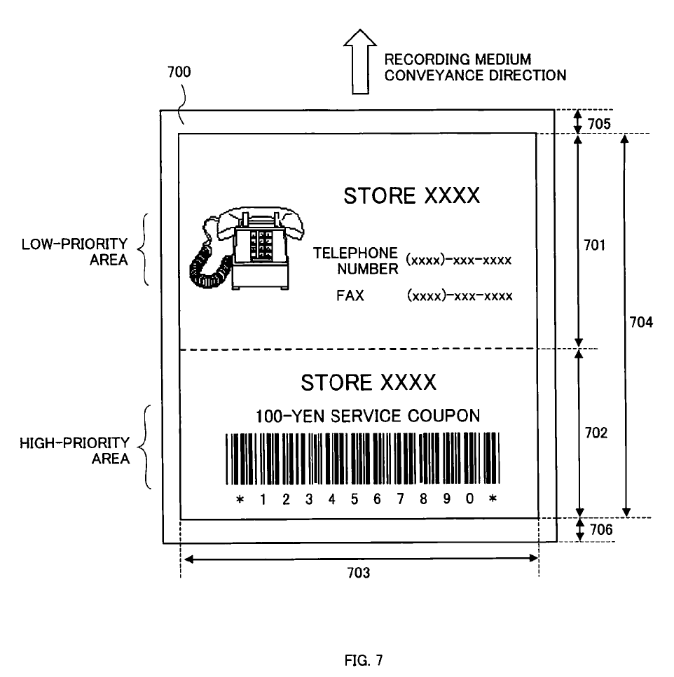

FIG. 7 shows an example of recording on a recording medium 700 by means of the recording device in this embodiment.

In this embodiment, data is recorded while the recording medium 700 is conveyed in the upward direction in the figure. In this recording example, the recording surface is divided into two areas, top and bottom. The bottom area is used as a high-priority area 702 in which discount ticket information is recorded, and the top area is used as a low-priority area 701 in which advertisement information is recorded.

The recording area size X 503 specified by the format command 510 is the number of horizontal dots of the recording area 703, and the recording area size Y 504 is the number of vertical dots of the recording area 704.

The priority area delimiting position 505 specified by the format command 510 represents the distance from the leading edge of the recording medium 700 to the delimiting position and, when the high-priority area specification (D) 506 in this example is “1 (bottom)”, corresponds to the dot position of the trailing edge of the low-priority area 701 (number of dots in height of low-priority area=701). On this recording device, a leading margin 705 and a trailing margin 706 are always provided on a recording medium to prevent data from being recorded in those margin areas.

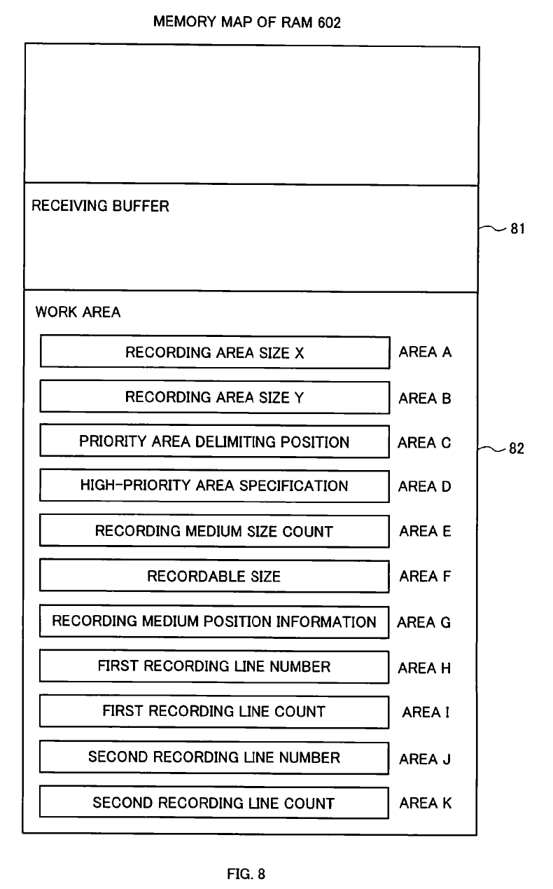

FIG. 8 shows the memory map of the RAM 602 in the recording device in this embodiment. The RAM 602 includes a receiving buffer 81 in which a command received from the PC 101 is temporarily stored and a work area 82. The work area 82 includes area A (recording area size X), area B (recording area size Y), area C (priority area delimiting position), area D (high-priority area specification), area E (recording medium size count), area F (recordable size), area G (recording medium position information), area H (first recording line number), area I (first recording line count), area J (second recording line number), and area K (second recording line count). The first recording line number is a parameter that specifies the first line of the recording data recorded in leading edge side recording area of the recording medium with the delimiting position as the boundary, and the first recording line count is a parameter that specifies the number of lines stored in the area. The second recording line number is a parameter that specifies the first line of the recording data recorded in trailing edge side recording area of the recording medium, and the second recording line count is a parameter that specifies the number of lines stored in the area.

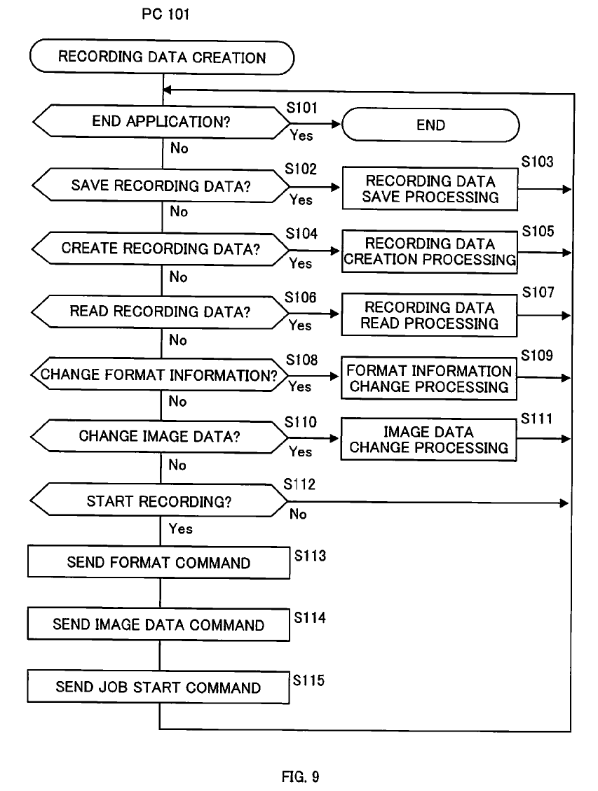

FIG. 9 is a flowchart showing the flow of the processing executed by the recording data creation application software program stored in the PC 101 in this embodiment. The MPU 200 reads the application program from the hard disk drive 202 into the RAM 201 to execute this processing.

When this processing is started by the user, the user can select various types of processing via the keyboard 103 or the mouse 104 for execution. When the user selects “End application” (S101, Yes), the application program is terminated. When the user selects “Save recording data” (S102, Yes), the program saves recording data, currently being edited, onto the hard disk drive 202 (S103). When the user selects “Create recording data” (S104, Yes), the program discards the recording data currently being edited and creates new recording data (S105). When the user selects “Read recording data” (S106, Yes), the program reads another piece of recording data from the hard disk drive 202 (S107). When the user selects “Change format information” (S108, Yes), the program starts format information change processing (S109) to allow the user to change the parameters of the format command 510. For example, the user can set the priority area delimiting position parameter 505, which sets the priority delimiting position in the recording data, or the high-priority area specification parameter 506 which specifies which area, top or bottom, is the high-priority area. When the user selects “Change image data” (S110, Yes), the program changes the image data, for example, edits the image data or reads another piece of image data (S111). When the user selects “Start recording” (S112, Yes), the program converts the recording data, currently being edited, to the commands, that is, to the format command, image data command, and the job start command and, via the printer interface 206, sends the commands to the recording device (S113, S114, S115).

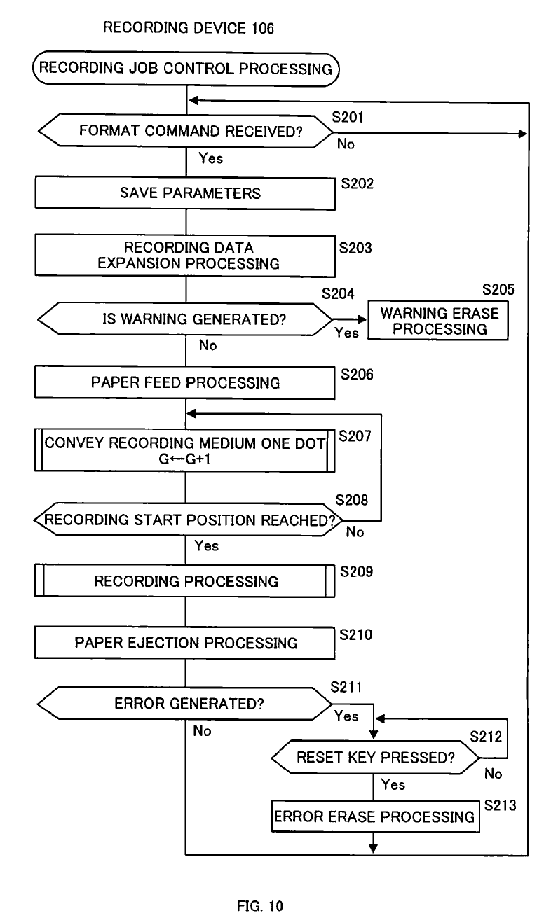

FIG. 10 is a flowchart showing the flow of the recording job control processing in the recording device 106 in this embodiment. This processing is executed by the MPU 600 that reads the control program from the program ROM 601 of the recording device 106.

When the recording device is turned on, various types of initialization processing are performed normally and, when the recording device becomes ready for receiving data, the processing is started. First, the recording device checks if the format command is received from the PC 101 (S201). If the format command is received (S201, Yes), the parameters, that is, the recording area size X 503, recording area size Y 504, priority area delimiting position 505, and the high-priority area specification 506, are saved in area A to area D in the RAM 602 (S202). In the description below, the variables A-D are used respectively as the parameters representing the values of areas A-D. This correspondence applies also to the other parameters.

Next, the image data 509 of the image data command 520, which is successively received, is expanded into the VRAM 603 as the recording data until the job start command 530 is received (S203). When the recording data expansion is terminated, a check is made if a warning has been generated (S204). If a warning has been generated (S204, Yes), the warning erase processing (S205) is performed to turn off the Warning LED 303 and erase the warning display displayed on the LCD 300. Next, one recording medium is fed from the paper feed unit to the recording unit by means of the paper feed roller 403 (S206) for conveying the medium to the main body. The recording medium is further conveyed by the conveyor belt 400 until it reaches the recording position (S208, Yes). G (recording medium position information), which indicates the conveyance distance from the TOF sensor, is incremented each time the recording medium is conveyed one dot after the leading edge of the paper is detected by the TOF sensor (S207). When the recording medium reaches the recording start position, the recording processing is executed (S209).

Whether or not the recording start position is reached is determined in step S208 based on the following determination condition.

Recording start position reached: (Distance from recording head to TOF)+Leading edge margin≦G

Recording start position not reached: (Distance from recording head to TOF)+Leading edge margin>G

After recording is terminated, the paper ejection processing (S210) is performed. After that, if an error has been generated (S211, Yes), the recording device waits until the Reset key 304 is pressed. If the Reset key 304 is pressed (S212, Yes), the error erase processing (S213) is performed to turn off the Error LED 302 and the error display on the LCD 300 is erased. If an error is not generated (S211, No), the recording device waits for the format command to be received again (S201).

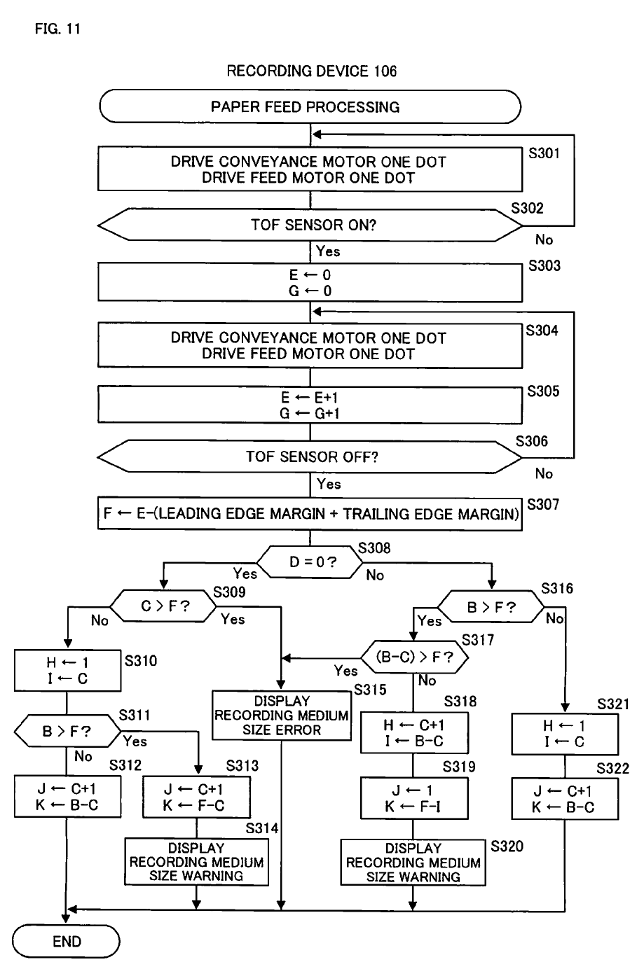

FIG. 11 is a flowchart showing the flow of the paper feed processing performed in the recording device 106 in this embodiment. This processing is executed by the MPU 600 that reads the control program from the program ROM 601.

In the paper feed processing, the conveyor motor and the paper feed motor are driven, one dot at a time, until the TOF sensor is turned on (S301). When the TOF sensor is turned on (S302, Yes), the value of “0” is assigned to E(recording medium size count) and G(recording medium position information) to initialize them (S303). Next, until the TOF sensor is turned off, the conveyor motor and the paper feed motor are driven, one dot at a time, (S304) and E(recording medium size count) is incremented (S305). At the same time, G(recording medium position information), which indicates the conveyance distance from the TOF sensor, is also incremented each time the recording medium is conveyed one dot. When the TOF sensor is turned off (S306, Yes), the recordable size value calculated by “E−(leading margin+trailing margin)” is stored in F(recordable size) in the RAM 602 (S307).

The subsequent processing depends on whether D(high-priority area specification) is “0” or not.

If D(high-priority area specification) specifies the top area, that is, its value is “0” (S308, Yes), control is passed to step S309; conversely, if D(high-priority area specification) specifies the bottom area, that is, its value is “1” (S308, No), control is passed to step S316.

In step S309, C(priority area delimiting position) and F(recordable size) are compared with each other. If C(priority area delimiting position) is equal to or smaller than F(recordable size) (S309, No), the following are set in step S310.

H(first recording line number)=1
I(first recording line count)=C

Next, in step S311, B(recording area size Y) and F(recordable size) are compared with each other. If B(recording area size Y) is equal to or smaller than F(recordable size) (S311, No), all the recording area can be recorded and so the recording data need not be changed. In this case, the following are set in step S312 and the processing is terminated.

J(second recording line number)=C+1
K(second recording line count)=B−C

If B(recording area size Y) is larger than F(recordable size) in step S311 (S311, Yes), all the high-priority area can be recorded but a part of low-priority area cannot be recorded. In this case, the following are set (S313).

J(second recording line number)=C+1
K(second recording line count)=F−C
After that, the recording medium size warning display processing (S314) is performed to display a warning message on the LCD 300 and turn on the Warning LED 303. After that, the processing is terminated.

If C(priority area delimiting position) is larger than F(recordable size) in step S309 (S309, Yes), all the high-priority area cannot be recorded and, so, the recording medium size error display processing (S315) is performed to display an error message on the LCD 300 and turn on the Error LED 302, and the processing is terminated.

In step S308, if D(high-priority area specification) specifies “1”, that is, it specifies the bottom area (S308, No) and if B(recording area size Y) is larger than F(recordable size) (S316, Yes), B−C (high-priority area size) and F(recordable size) are compared with each other (S317). If B−C (high-priority area size) is larger than F(recordable size) (S317, Yes), all the high-priority area cannot be recorded even if the high-priority area is moved to the top side, the recording medium size error display processing (S315) is performed to display the error message on the LCD 300 and turn on the Error LED 302, and the processing is terminated.

If B−C(high-priority area size) is equal to or smaller than F(recordable size) in step S317 (S317, No), the recording position of the high-priority area and that of the low-priority area are exchanged because the high-priority area can be recorded if it is moved to the top side. Note that, because a part of the low-priority area cannot be recorded, the following are set in steps S318 and S319.

H(first recording line number)=C+1
I(first recording line count)=B−C
J(second recording line number)=1
K(second recording line count)=F−I
After that, the recording medium size warning display processing (S320) is performed to display the warning message on the LCD 300 and turn on the Warning LED 303, and the processing is terminated.

If B(recording area size Y) is equal to or smaller than F(recordable size) in step S316 (S316, No), all the recording area can be recorded and so the recording data need not be changed. In this case, the following are set in step S321.

H(first recording line number)=1
I(first recording line count)=C
And, the following are set in step S322.
J(second recording line number)=C+1
K(second recording line count)=B−C
After that, the processing is terminated.

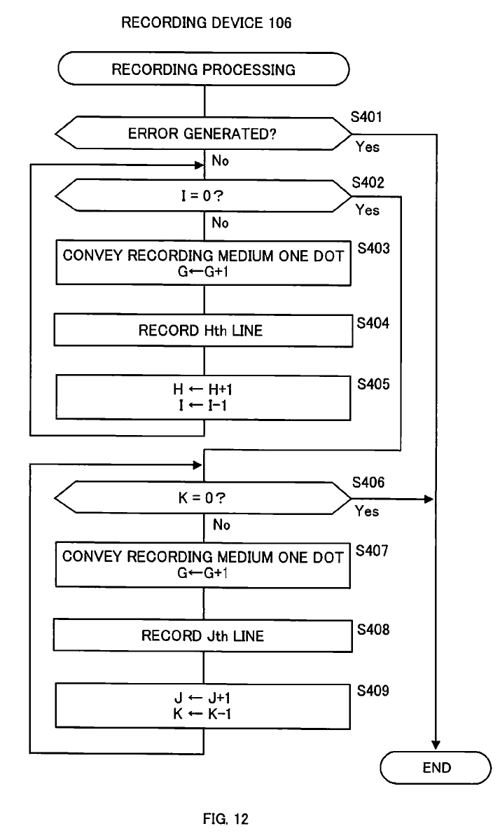

FIG. 12 is a flowchart showing the flow of the recording processing performed by the recording device in this embodiment. This processing is executed by the MPU 600 that reads the control program from the program ROM 601.

First, the recording device checks if an error has been generated (S401). If an error has been generated (S401, Yes), the processing is terminated without performing the recording processing. If an error is not generated (S401, No), the recording device checks I(first recording line count) (S402). If I is not “0” (S402, No), the recording device conveys the recording medium one dot (S403) and ejects ink from the recording head 401 to record the recording data in the VRAM 603 corresponding to a line whose line number is set in H(first recording line number) (S404). Then, H is incremented and I is decremented (S405) and control is passed back to step S402.

The value of “0”, if stored in I (S402, Yes), means that the recording of the top area is terminated. The recording device checks K(second recording line count) and, if K is not “0” (S406, No), conveys the recording medium one dot (S407), and ejects ink from the recording head 401 to record the recording data stored in the VRAM 603 corresponding to a line whose number is set in J(second recording line number) (S408). After that, J is incremented and K is decremented (S409), and control is passed back to step S406.

The value of “0”, if stored in K (S406, Yes), means that the recording of the bottom area is terminated, and the processing is terminated. G(recording medium position information), which indicates the conveyance distance from the TOF sensor, is incremented each time the recording medium is conveyed one dot (S403, S407).

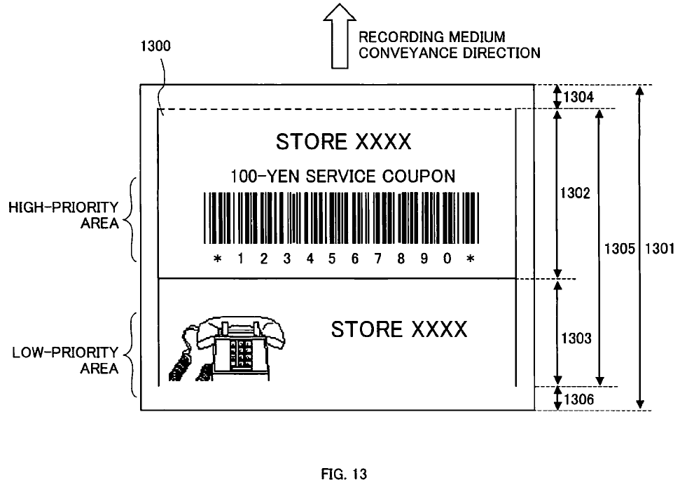

FIG. 13 shows an example of recording on a recording medium 1300 on which the recording position of the high-priority area and that of the low-priority area are exchanged in the recording device in this embodiment. In this example, because a recordable size 1305, calculated by subtracting a leading edge margin 1304 and a trailing edge margin 1306 from a recording medium size 1301, is smaller than B(recording area size Y), the recording position of a high-priority area 1302 in which discount ticket information is recorded and the recording position of a low-priority area 1303 in which advertisement information is recorded are exchanged. In this case, a part of the low-priority area 1303 cannot be recorded and, so, the warning message is displayed on the operation panel 113 of the recording device.

If the recordable size of a recording medium is smaller than the recording data size (page size) and a high-priority area such as discount ticket information area cannot be recorded as in this case, a check is made in this embodiment if the high-priority data can be recorded by changing (exchanging) the recording position with the recording position of a low-priority area such as that for advertisement information. If the high-priority data can be recorded in this way, the recording position is changed to record the high-priority data preferentially.

As described above, if the recordable size on a recording medium is smaller than the recording data size, the recording is performed by changing the recording data to predetermined recording data according to the priority of the areas.

In this embodiment described above, though a recording medium size is detected by the TOF sensor provided in the recording medium conveyance path while conveying a recording medium, the present invention is not limited to this configuration. The present invention is effective regardless of the type of the recording medium size detection unit; for example, a line sensor may also be provided on the paper feed unit in the direction horizontal to the conveyance direction to detect the size of a recording medium that is set in the paper feed unit.

### Second Embodiment

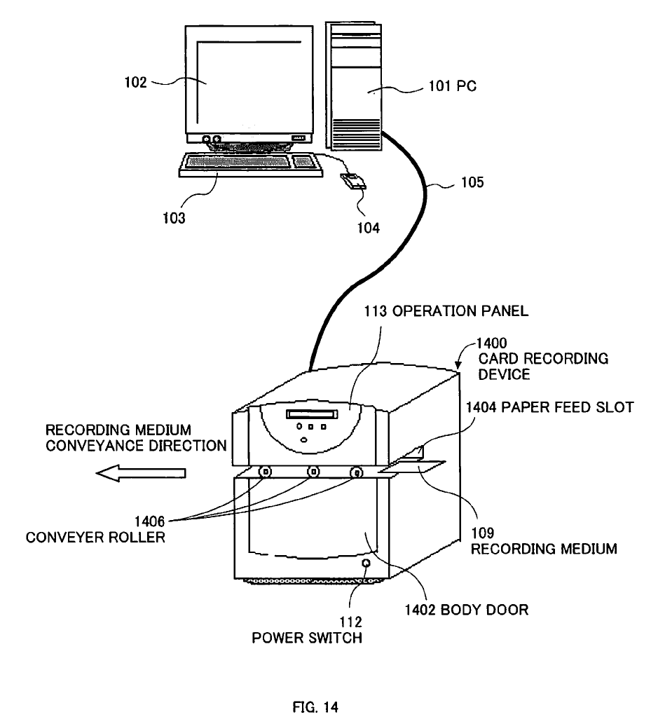

FIG. 14 is a diagram showing the general configuration of a recording system in a second embodiment of the present invention in which a personal computer (PC) 101 is connected to a card recording device 1400, which uses an inkjet line recording head (a recording head). The PC 101 is the same as that in the first embodiment.

On the recording device 1400 in this embodiment, there are provided an operation panel 113, a power switch 112 that controls the power on/off, a body door 1402 that is opened and closed to exchange an ink tank or remove a recording medium jam, a paper feed slot 1404 through which a recording medium 109 is inserted, and conveyer rollers 1406 that convey the recording medium 109 in the arrow direction in the figure. This recording device 1400 is a recording device into which the user manually inserts a recording medium through the paper feed slot 1404 for recording.

The PC 101 and the recording device 1400 are connected by a printer cable 105. The recording device 1400 receives control commands from the PC 101 via the printer cable 105 and saves recording data in the nonvolatile memory. Although the PC 101 is connected to the recording device 1400 in FIG. 14, this recording device 1400 may also be used offline, in which case the recording device 1400 is required to be connected to the PC 101 only when recording data is saved in the nonvolatile memory.

The configuration of the PC 101 used in this embodiment is the same as that of the PC 101 in the first embodiment shown in FIG. 2. The operation panel of the recording device 1400 in this embodiment is the same as that of the recording device in the first embodiment shown in FIG. 3.

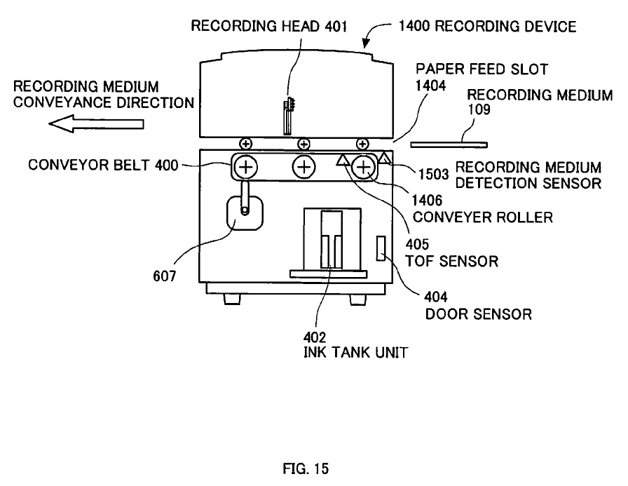

FIG. 15 is a cross section diagram showing the general mechanical configuration of the internal of the recording device 1400 used in this embodiment.

The recording device 1400 comprises a recording medium detection sensor 1503 that detects that the recording medium 109 has been inserted into the paper feed slot 1404, a conveyance motor 607 that rotates conveyer rollers 1406, a conveyor belt 400 that, when driven by the conveyer rollers 1406, conveys the recording medium 109, a TOF sensor 405 that detects the position and the size of the recording medium, a recording head 401 from which ink is ejected, an ink tank unit 402 that supplies ink to the recording head 401, and a door sensor 404 that detects the opening/closing of the body door.

The ink tank unit 402, connected to the recording head 401 by a tube (not shown), controls a recovery motor to supply ink to the recording head.

When inserted into the paper feed slot 1404 of the recording device 1400 and detected by the recording medium detection sensor 1503, the recording medium 109 is fed into the direction, indicated by the arrow in the figure, by the conveyor belt 400 that is driven and rotated by the rotation of the conveyance motor 607.

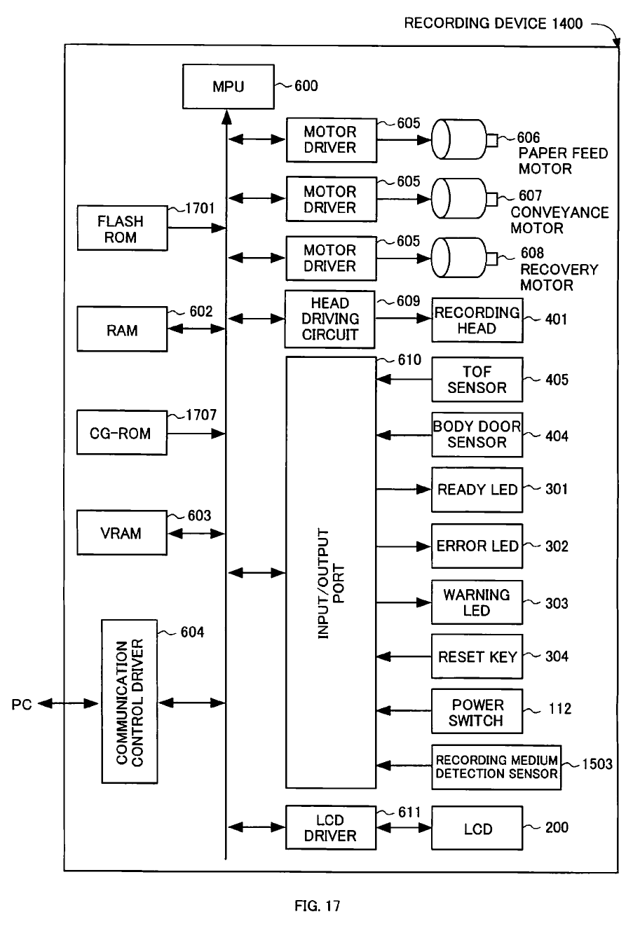

When the recording medium 109 is detected by the TOF sensor 405, the conveyance of the recording medium is stopped and the recording data, saved in advance, is expanded into a VRAM 603 (FIG. 17) that will be described below. After the expansion of the recording data is finished, the recording medium 109 is conveyed again and, when it reaches the recording position, ink is ejected from the recording head 401 onto the surface of the recording medium according to the image formation signal to form an image.

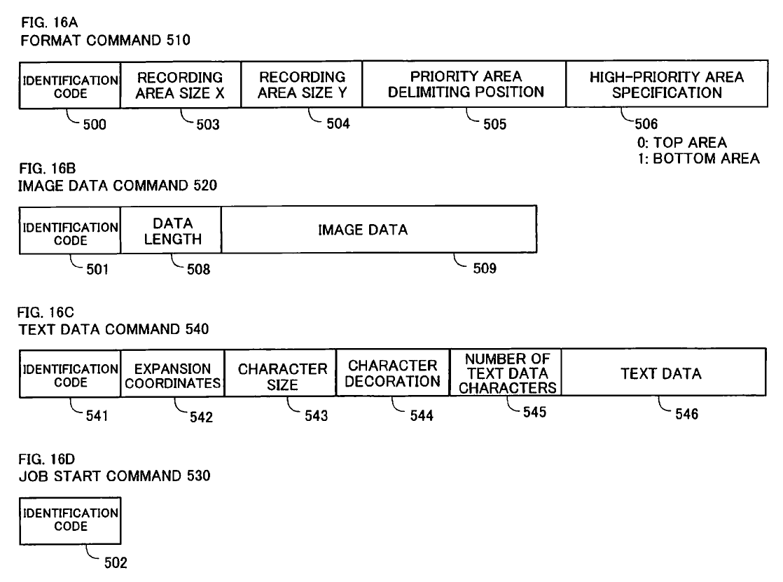

FIGS. 16A-16D are diagrams showing the structure of the control commands used in this embodiment. The following control commands are available in this embodiment: a format command 510, an image data command 520, a text data command 540, and a job start command 530. This embodiment is different from the first embodiment in that text data can be processed.

The format command 510 shown in FIG. 16A comprises a recording area size X 503, a recording area size Y 504, a priority area delimiting position 505, and a high-priority area specification 506, as with the format command 510 shown in FIG. 5A.

The image data command 520 shown in FIG. 16B includes an identification code 501, an image data 509 that will be expanded into the print buffer, and its data length 508, as with the image data command 520 shown in FIG. 5B.

The text data command 540 shown in FIG. 16C includes an identification code 541, expansion coordinates 542 used to expand text into the print buffer, a character size 543, a character decoration 544 such as a bold/italic specification, a number of text data characters 545, and text data 546.

The job start command 530 shown in FIG. 16D, which includes only an identification code 502, indicates the end of registration data and starts a job, as with the job start command 530 shown in FIG. 5C.

The PC 101 outputs those commands to the printer cable 105 via the printer interface.

In this embodiment, recording data can be divided into two areas, top and bottom, which are arranged in the recording medium conveyance direction and for each of which two stages of priority, high-priority area and low-priority area, can be specified as in the first embodiment. As described above, a high-priority area specification 506 of “0” indicates that the top side of the position delimited by the priority area delimiting position 505 is a high-priority area, while the high-priority area specification 506 being “1” indicates that the bottom side of the position delimited by the priority area delimiting position 505 is a high-priority area.

FIG. 17 is a simplified electrical block diagram of the recording device 1400 in this embodiment. The same reference numerals are used to denote the same elements of the recording device 106 in the first embodiment shown in FIG. 6.

A microprocessor (MPU) 600 executes the control program, stored in a nonvolatile-memory flash ROM 1701 that can be electrically rewritable, one block at a time, to perform the following control operation.

(1) Controls a motor driver 605 and drives the conveyance motor 607 when the recording medium 109 is detected by a recording medium detection sensor 1503 under control of an input/output port 610.
(2) Stops the driving of the conveyance motor 607 when the conveyed recording medium 109 is detected by the TOF sensor 405, expands the recording image into the VRAM 603 using bit-mapped font data stored in a CG(Character Generator) ROM 1707 and image data stored in the flash ROM 1701, and drives the conveyance motor 607 again.
(3) Performs turn-on/turn-off control of an Error LED 302, a Warning LED 303, and a Ready LED 301 via the input/output port 610 according to the status of the recording device, and controls an LCD driver 1710 to display a message on an LCD 300.
(4) Periodically monitors, via the input/output port 610, if a Reset key 304 or a power switch 112 is pressed.
(5) Controls a head driving circuit 609, based on the recording medium position information relative to the leading edge position of the recording medium detected by the TOF sensor 405 under control of the input/output port 610, drives the recording head 401 to eject ink from it to record image data, which is expanded in the VRAM 603, onto the recording medium.

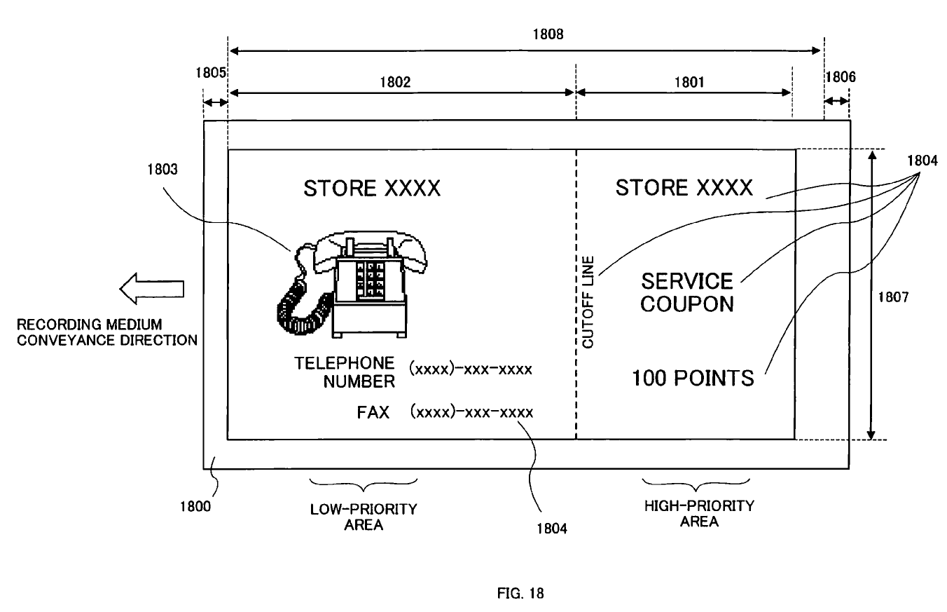

FIG. 18 is a diagram showing an example of recording on a recording medium on the recording device 1400 in this embodiment. The recording device 1400 in this embodiment conveys a recording medium 1800 in the upper direction, indicated by the arrow in the figure, and records data on it. Note that a leading edge margin 1805 and a trailing edge margin 1806 are always provided to prevent data from being recorded in those areas.

The recording data has two areas: a top-side (area where information is recorded first), low-priority area 1802 in which advertisement information is recorded and bottom-side (area where information is recorded next), high-priority area 1801 in which discount ticket information is recorded. Recording data is composed of text data 1804 and image data 1803. The recording area size X 503, specified by the format command 510, corresponds to the number of horizontal dots 1807 of the recording area, and the recording area size Y 504 corresponds to the vertical recordable size 1808.

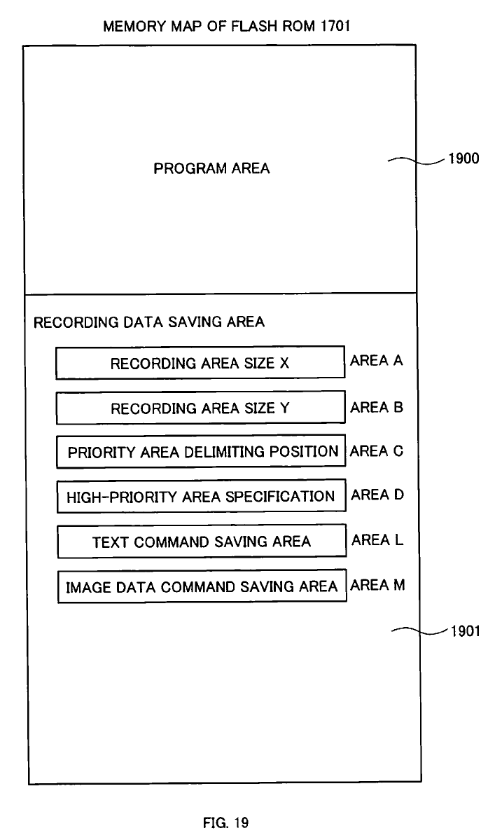

FIG. 19 is a diagram showing the internal configuration of the flash ROM 1701 (FIG. 17) in the recording device in this embodiment.

The flash ROM 1701 has a program area 1900 in which the control program is stored and a recording data saving area 1901. The recording data saving area has the areas in which the parameters of the format command are saved, that is, area A(recording area size X), area B(recording area size Y), area C(priority area delimiting position), and area D(high-priority area specification), area L in which the text data command is saved (text command saving area), and area M in which the image data command is saved (image data command saving area).

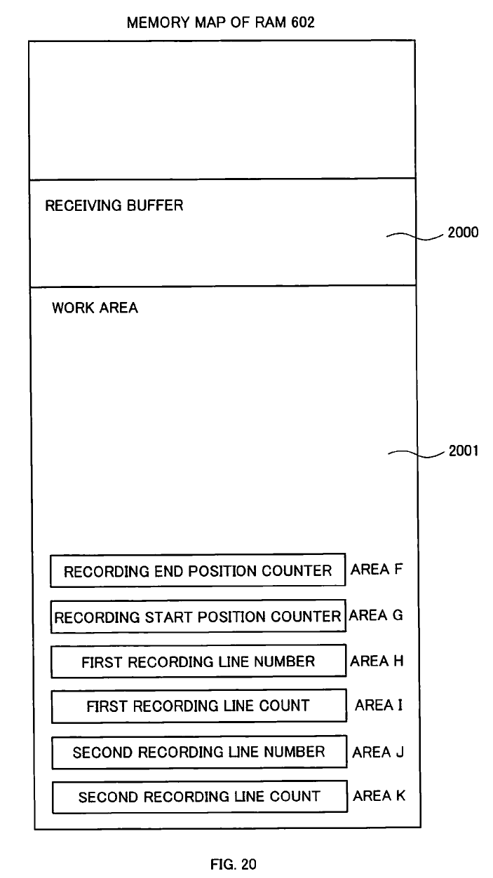

FIG. 20 is a memory map of the RAM 602 (FIG. 17) in the recording device in this embodiment.

The RAM 602 has a receiving buffer 2000 in which a command received from the PC 101 is temporarily stored and a work area 2001. The work area 2001 has area F(recording end position counter), area G(recording start position counter), area H(first recording line number), area I(first recording line count), area J(second recording line number), and area K(second recording line count). Note that area F and area G are different from those in the first embodiment.

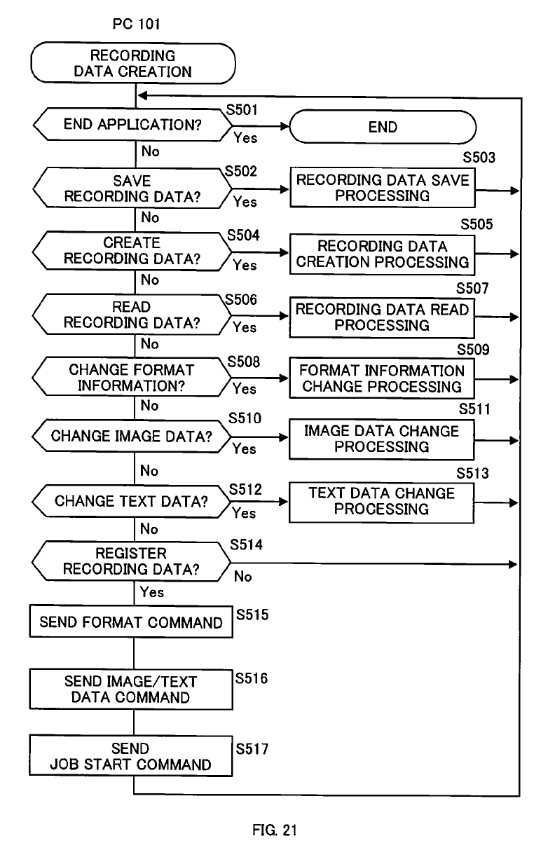

FIG. 21 is a flowchart showing the flow of the recording data creation application software program executed on the PC in this embodiment. This processing is executed by the MPU 200 that reads this application program from the hard disk drive 202.

When this processing is started by the user, the user can select various types of processing via the keyboard 103 or the mouse 104 for execution. When the user selects “End application” (S501, Yes), the application is terminated. When the user selects “Save recording data” (S502, Yes), the program performs the recording data saving processing for saving recording data, currently being edited, onto the hard disk drive 202 (S503). When the user selects “Create recording data” (S504, Yes), the program discards the recording data currently being edited and performs the recording data creation processing for creating new recording data (S505). When the user selects “Read recording data” (S506, Yes), the program reads another piece of recording data from the hard disk drive (HDD) 202 (S507). When the user selects “Change format information” (S508, Yes), the program starts format information change processing (S509) for changing the format information to allow the user to change the parameters of the format command 510. For example, the user can set the priority area delimiting position parameter 505 that sets the priority delimiting position in the recording data, or the high-priority area specification parameter 506 that specifies which area, top or bottom, is the high-priority area. When the user selects “Change image data” (S510, Yes), the program performs the image data change processing, for example, the program edits the image data or reads another piece of image data (S511). When the user selects “Change text data” (S512, Yes), the program performs the text data change processing (S513) such as the editing of text data or creation/deletion of text data. When the user selects “Register recording data” (S514, Yes), the program converts the recording data, currently being edited, to the commands, that is, to the format command, image data command, text data command, and job start command and, via the printer interface 206, sends the commands to the recording device (S515, S516, S517).

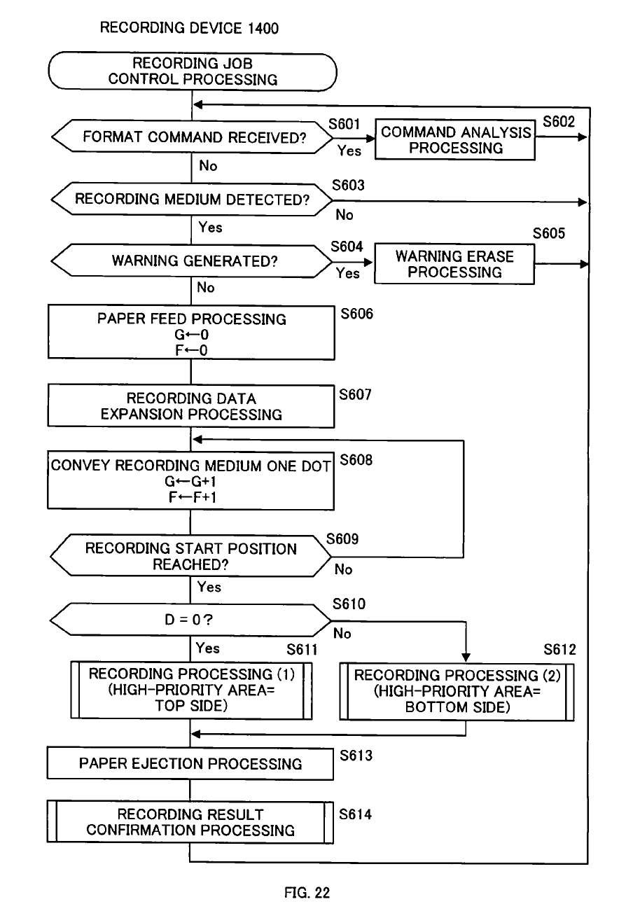

FIG. 22 is a flowchart showing the flow of the recording job control processing in the recording device 1400 in this embodiment. This processing is executed by the MPU 600 that reads the control program from the flash ROM 1701.

When the recording device is turned on and various types of initialization processing are performed normally, the processing is started. First, if the format command is received (S601, Yes), the command analysis processing is performed to receive and analyze the commands (S602) and, when the job start command 530 is received last, the received and analyzed data are saved in the flash ROM 1701.

When the recording medium 109 is inserted into the paper feed slot 1404 and the recording medium detection sensor detects the recording medium (S603, Yes), a check is made if a warning has been generated (S604). If a warning has been generated (S604, Yes), the warning erase processing (S605) is performed to turn off the Warning LED 303 and to erase the warning display displayed on the LCD 300. After that, the recording medium 109 is fed to the TOF sensor, and 0 is assigned to G(recording start position counter) and F(recording end position counter) to initialize them (S606).

Next, the recording data expansion processing (S607) is performed to expand the image data, saved in the flash ROM 1701, into the VRAM 603, the bit mapped data corresponding to the text data is read from the CG ROM 1707 and expanded into the VRAM 603, and the information required for recording is calculated and set based on the parameters of the format command.

The parameters required for recording are set as follows.

First line number of area recorded in top side: H(first recording line number)=1
Number of lines of area recorded in top side: I(first recording line count)=C
First line number of area recorded in bottom side: J(second recording line number)=C+1
Number of lines of area recorded in bottom side: K(second recording line count)=B−C

After the recording data expansion processing (S607) is terminated, the recording medium is conveyed (S608), one dot at a time, until the recording medium 109 reaches the recording start position (S609, Yes). G(recording start position counter), a conveyance amount counter for detecting the recording position, is incremented each time the recording medium is conveyed one dot after this processing is performed and before the recording is started. F(recording end position counter), a conveyance amount counter for detecting the recording end position, is incremented each time the recording medium is conveyed one dot after the trailing edge of the recording medium is detected by the TOF sensor and before the recording is terminated.

Whether or not the recording start position is reached is determined in step S609 based on the following determination condition.

Recording start position reached: (Distance from recording head to TOF)+Leading edge margin≦G

Recording start position not reached: (Distance from recording head to TOF)+Leading edge margin>G

When the recording medium reaches the recording start position (S609, Yes), the recording device checks the value of D(high-priority area specification). If D(high-priority area specification) is “0” (S610, Yes), the recording device performs the recording processing (1) provided for execution when high priority is assigned to the top side (S611); if D(high-priority area specification) is “1” (S610, No), the recording device performs the recording processing (2) provided for execution when high priority is assigned to the bottom side (S612). After the recording is terminated, the paper ejection processing is performed (S613), the recording result confirmation processing is performed to confirm the recording status of the high-priority area and the low-priority area (S614), and the error/warning processing is performed as necessary. After that, the recording device waits for the format command again (S600).

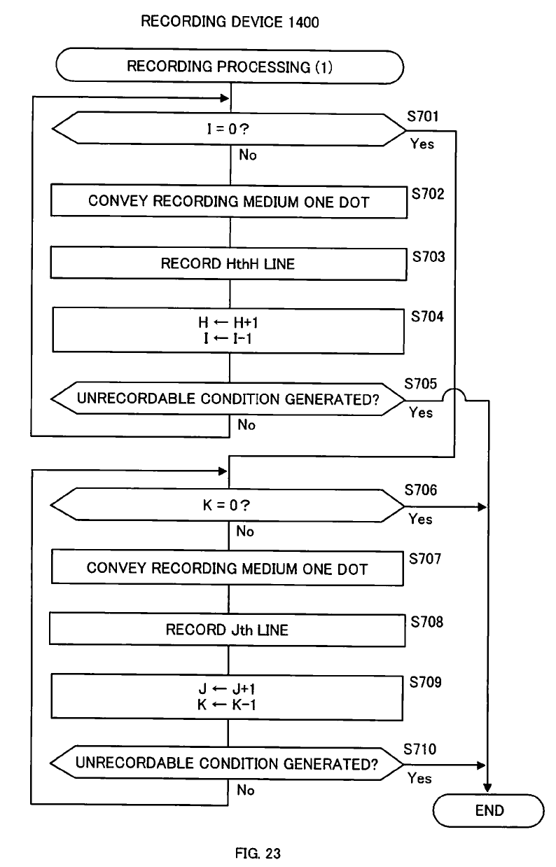

FIG. 23 is a flowchart showing the flow of recording processing (1) in this embodiment. When the high-priority area is in the top side (S610, Yes), this processing is executed by the MPU 600 that reads the control program from the flash ROM 1701.

First, the recording device checks I(first recording line count). If I is not “0” (S701, No), the recording device conveys the recording medium one dot (S702) and ejects ink from the recording head 401 to record the recording data in the VRAM 603 corresponding to a line whose line number is set in H(first recording line number) (S703). Then, H(first recording line number) is incremented and I(first recording line count) is decremented (S704). If an unrecordable status is detected (S705, Yes), the processing is terminated.

The value of I, if “0” (S701, Yes), indicates that the high-priority area recording in the top side is terminated normally. The recording device checks K(second recording line count). If K is not “0” (S706, No), the recording device conveys the recording medium one dot (S707) and ejects ink from the recording head 401 to record the recording data in the VRAM 603 corresponding to a line whose line number is set in J(second recording line number) (S708). Then, J is incremented, and K is decremented (S709). If an unrecordable status is detected (S710, Yes), the processing is terminated. If the value of K, if “0” (S706, Yes), indicates that the low-priority area recording in the bottom side is terminated normally and, in this case, the processing is terminated.

Whether or not an unrecordable status is generated is determined in steps S705 and S710 based on the following determination condition.

UNRECORDABLE: (Distance from recording head to TOF)−Trailing edge margin≦F
RECORDABLE: (Distance from recording head to TOF)−Trailing edge margin>F

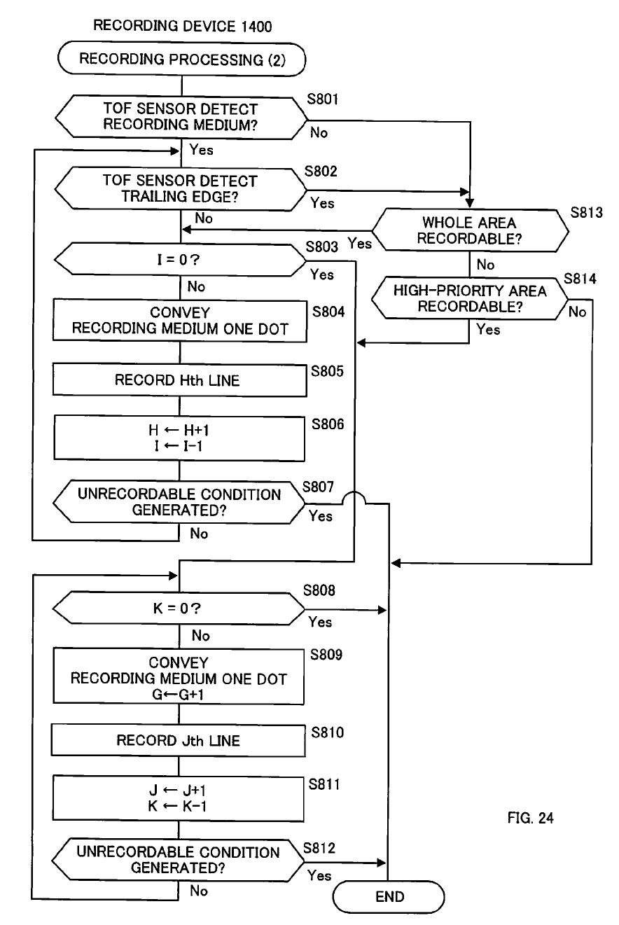

FIG. 24 is a flowchart showing the flow of recording processing (2) in this embodiment. When the high-priority area is in the bottom side (S610, No), this processing is executed by the MPU 600 that reads the control program from the flash ROM 1701.

First, the recording device checks if a recording medium is detected by the TOF sensor (S801). If the TOF sensor does not detect a recording medium (S801, No), control is passed to step S803. If the TOF sensor detects a recording medium, the recording device checks if the TOF sensor detects the trailing edge (S802). If it is determined in step S813 that the whole area (low-priority area+high-priority area) is recordable, control is passed to step S803. If the whole area is unrecordable (S813, No), control is passed to step S814. If the high-priority area is unrecordable (S814, No), this processing is terminated. If the high-priority area is recordable (S814, Yes), the recording of the high-priority area is started.

Whether or not the whole area is recordable is determined in step 813 based on the following determination condition.

Remaining recordable size=(Distance from recording head to TOF)−Trailing edge margin−F
RECORDABLE: (Remaining recordable size)≧(I+K)
UNRECORDABLE: (Remaining recordable size)<(I+K)

Whether or not the high-priority area is recordable is determined in step 814 based on the following determination condition.

RECORDABLE: (Remaining recordable size)≧(K)
UNRECORDABLE: (Remaining recordable size)<(K)

If the TOF sensor does not detect the trailing edge (S802, No), the recording device checks I(first recording line count). If I is not “0” (S803, No), the recording device conveys the recording medium one dot (S804) and ejects ink from the recording head 401 to record the recording data in the VRAM 603 corresponding to a line whose line number is set in H(first recording line number) (S805). H(first recording line number) is incremented and I(first recording line count) is decremented (S806). If an unrecordable status is detected because of the recording medium size (S807, Yes), the processing is terminated.

The value of I, if “0” (S803, Yes), indicates that the low-priority area recording in the top side is terminated normally. The recording device checks K(second recording line count). If K is not “0” (S808, No), the recording device conveys the recording medium one dot (S809) and ejects ink from the recording head 401 to record the recording data in the VRAM 603 corresponding to a line whose line number is set in J(second recording line number) (S810). Then, J is incremented, and K is decremented (S811). If an unrecordable status is detected (S812, Yes), the processing is terminated. The value of K, if “0” (S808, Yes), also indicates that the high-priority area recording in the bottom side is terminated normally and, in this case, the processing is terminated.

Whether or not an unrecordable status is generated is determined in steps S807 and S812 based on the following determination condition.

UNRECORDABLE: (Distance from recording head to TOF)−Trailing edge margin≦F
RECORDABLE: (Distance from recording head to TOF)−Trailing edge margin>F

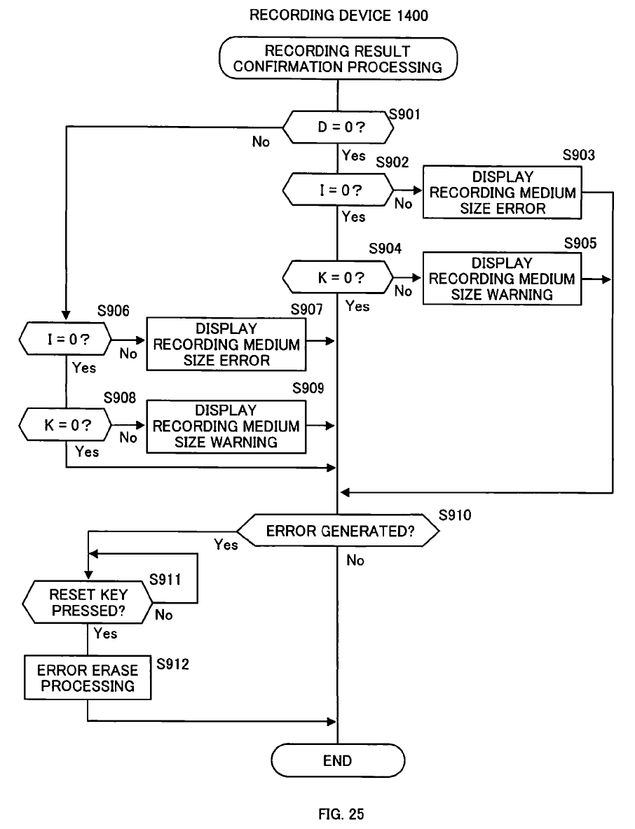

FIG. 25 is a flowchart showing the flow of the recording result confirmation processing in this embodiment. After the paper ejection processing (S613) this processing is executed by the MPU 600 that reads the control program from the flash ROM 1701.

First, the recording device checks the recording position of the high-priority area based on D. If the recording position of the high-priority area is in the top side (S901, Yes) but if the recording of the high-priority area is not yet finished (S902, No), the recording medium size error display processing (S903) is executed to display an error message on the LCD 300 and turn on the Error LED 302. If the recording of the high-priority area is finished (S902, Yes) but if the recording of the low-priority area is not yet finished (S904, No), the recording medium size warning display processing (S905) is executed to display a warning message on the LCD 300 and turn on the Warning LED 303.

If the recording position of the high-priority area is in the bottom side (S901, No) but if the recording of the high-priority area is not yet finished (S906, No), the recording medium size error display processing (S907) is also executed to display an error message on the LCD 300 and turn on the Error LED 302. If the recording of the high-priority area is finished (S906, Yes) but if the recording of the low-priority area is not yet finished (S908, No), the recording medium size warning display processing (S909) is executed to display a warning message on the LCD 300 and turn on the Warning LED 303. If an error has been generated (S910, Yes), the recording device waits for the user to press the Reset key and, when the reset key is pressed (S911, Yes), the error erase processing (S912) is executed to turn off the Error LED 302, the error display on the LCD 300 is erased, and the processing is terminated.

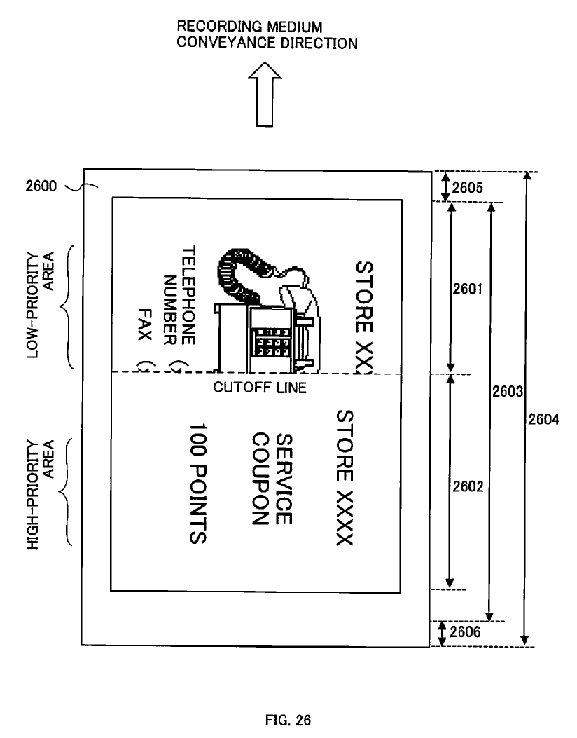

FIG. 26 shows an example of a recording medium on which the high-priority area is recorded on the recording device in this embodiment with the recording of the low-priority area interrupted (that is, a part of its recording data is lost). In the recording example of this recording medium 2600, a recordable size 2603, which is calculated by subtracting a leading edge margin 2605 and a trailing edge margin 2606 from a recording medium size 2604, is smaller than B(recording area size Y). Therefore, the recording of a low-priority area 2601 in which advertisement information is recorded is interrupted but a high-priority area 2602 in which discount ticket information is recorded is recorded. A warning message is displayed on the operation panel 113 of the recording device because a part of the low-priority area 2601 is not recorded.

If the recordable size of the recording medium is smaller than the recording data size and if a high-priority area such as that for discount ticket information cannot be recorded as in the case given above, the recording of the low-priority area, such as that for advertisement information, is interrupted to record the high-priority data preferentially. BY doing so, the recording device in this embodiment performs the optimum recording processing based on the priority of the recording areas.

As described above, if the recording area size of a recording medium is smaller than the recording data size in a configuration such as that described above, the recording device in this embodiment allows high-priority information to be recorded preferentially.

### Third Embodiment

In the first embodiment and second embodiment, an example is shown in which recording data can be divided into two areas (top and bottom) which are arranged in the recording medium conveyance direction and for each of which two stages of priority (high-priority area and low-priority area) can be specified. The present invention is not limited to this case but may also be effective to a case in which recording data can be divided into three or more areas or three or more stages of priority can be set.

When recording data is divided into “three areas with three stages of priority, i.e., high-priority area, intermediate-priority area, and low-priority area” in the first embodiment when the recording area size of the recording medium is smaller than the recording data size, this division can be performed by unconditionally rearranging the recording positions of those areas in order of the high-priority area, intermediate-priority area, and low-priority area.

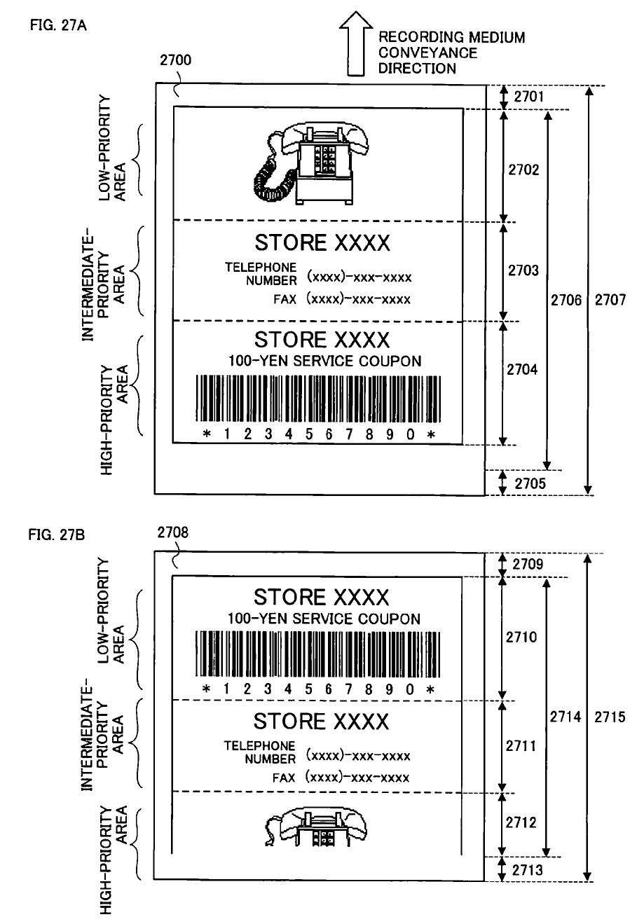

FIG. 27A shows an example of recording on a recording medium 2700 when all recording areas are normally recorded on the recording device in this embodiment, while FIG. 27B shows an example of recording on a recording medium 2708 on which the recording positions are rearranged in order of the high-priority area, intermediate-priority area, and low-priority area when the size of the recording medium 2700 is too small to record all areas.

In this embodiment, the recording media 2700 and 2708 are conveyed in the upward direction in the figure for recording. There are three areas on the recording media: high-priority areas 2704 and 2710 in which discount ticket information is recorded, intermediate-priority areas 2703 and 2711 in which the telephone number information is recorded, and low-priority areas 2702 and 2712 in which advertisement information is recorded.

The size calculated by subtracting a leading edge margin 2701 and a trailing edge margin 2705 from a recording medium size 2707 in the conveyance direction is a recording area size Y 2706 in which data can be actually recorded; similarly, the size calculated by subtracting a leading edge margin 2709 and a trailing edge margin 2713 from a recording medium size 2715 in the conveyance direction is a recording area size Y 2714 in which data can be actually recorded. On this recording device, the leading edge margins 2701 and 2709 and the trailing edge margins 2705 and 2713 are always provided to prevent data from being recorded in those areas. Because the recording data size 2702+2703+2704 is smaller than the recordable size 2706 on the recording medium 2700 in FIG. 27A, all recording data is recorded without rearranging the recording positions of the areas.

Because the recording data size 2710+2711+2712 is larger than the recordable size 2714 on the recording medium 2708 in FIG. 27B, the recording positions are rearranged in order of the high-priority area 2710, intermediate-priority area 2711, and low-priority area 2712 to preferentially record the areas with higher priority.

As a result of rearranging the recording positions, a part of the low-priority area 2712 recorded last is not recorded and, so, a warning message is displayed on the operation panel of the recording device.

### Fourth Embodiment

In the first embodiment to the third embodiment described above, recording data is divided into plural areas (for example, top and bottom) arranged in the recording medium conveyance direction. The present invention is not limited to this arrangement of areas. The present invention is applicable also to a case in which recording data is divided into the areas arranged orthogonally to the conveyance direction and in the width direction of the recording medium (for example, left part and right part) or to a case in which recording data is divided into the areas arranged in the conveyance direction and in the width direction.

This embodiment can be implemented by rearranging the recording positions of the high-priority area and the low-priority area when recording data is divided into plural areas arranged in the recording medium width direction orthogonal to the conveyance direction, that is, two areas and having two stages of priority (high-priority area and low-priority area), and when the horizontal recordable area size of the recording medium is smaller than the horizontal size of the recording data.

The configuration of this embodiment is different from that of the first embodiment in that a line sensor is added to the paper feed unit in the direction orthogonal to the recording medium as a detection unit for detecting the recording medium width size, and the recording medium is conveyed based on a conveyance base 2814. The conveyance base is a base with which one end of each of recording media of different widths is aligned when it is conveyed. The horizontal size of the recording medium is detected by the output signal from the line sensor.

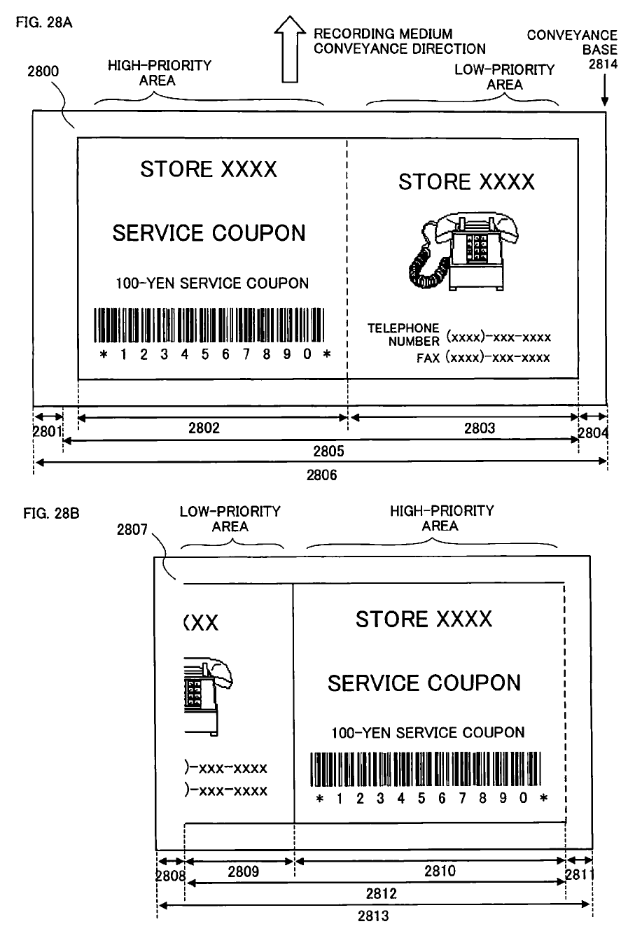

FIG. 28A shows an example of recording on a recording medium 2800 when all recording data is normally recorded on the recording device in this embodiment, while FIG. 28B shows an example of recording on a recording medium 2807 on which the recording positions are rearranged in order of the high-priority area and low-priority area beginning with the conveyance base 2814 side when the size of the recording medium 2800 is too small to record all recording data.

In this embodiment, the recording media 2800 and 2807 are conveyed in the upward direction in the figure for recording. There are two areas on each of the recording media: high-priority area in which discount ticket information is recorded and low-priority area in which advertisement information is recorded. The size calculated by subtracting a left margin 2801 and a right margin 2804 from a recording medium width size 2806 is an actual horizontal recordable size 2805; similarly, the size calculated by subtracting a left margin 2808 and a right margin 2811 from a recording medium size width size 2813 is an actual horizontal recordable size 2812. On this recording device, the left margins 2801 and 2008 and the right margins 2804 and 2811 are always provided to prevent data from being recorded in those areas.

Because the horizontal recording data size 2802+2803 is smaller than the horizontal recordable size 2805 in the example of recording on the recording medium 2800 in FIG. 28A, all recording data is recorded without rearranging the recording positions of the areas.

Because the horizontal recording data size 2802+2803 is larger than the horizontal recordable size 2812 in the example of recording on the recording medium 2807 in FIG. 28B, the recording positions are rearranged in order of the high-priority area 2810 and low-priority area 2809, beginning at the conveyance base 2814, to preferentially record the high-priority area. As a result of rearranging the recording positions, a part of the low-priority area 2809 recorded last is not recorded and, so, a warning message is displayed on the operation panel of the recording device.

### Fifth Embodiment

In the first embodiment, when a recording medium on the recording device is too small to record all recording data, the recording positions are rearranged so that a high-priority area can be recorded preferentially. The present invention is applicable also when a low-priority area other than a specified high-priority area is reduced in size, through automatic conversion, to fit the reduced area in a recordable area.

In this embodiment, the recording size medium warning display processing unit does not generate a warning as in the first embodiment, but automatically reduces a low-priority area so that it fits in the recordable area on a recording medium, in order to preferentially record the whole of a high-priority area.

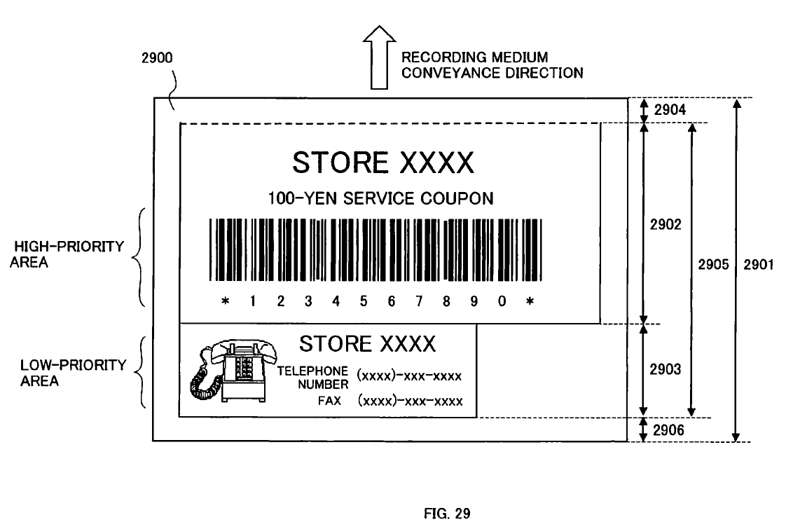

FIG. 29 is a diagram showing an example of a recording medium 2900 on which the positions of a high-priority area and a low-priority area are exchanged, and, the low-priority area is automatically reduced for recording, on the recording device in this embodiment.

In the example of recording on the recording medium 2900, because a recordable size 2905, which is calculated by subtracting a leading edge margin 2904 and a trailing edge margin 2906 from a recording medium size 2901, is smaller than B(recording area size Y), the recording position of a high-priority area 2902 in which discount ticket information is recorded and the recording position of a low-priority area 2903 in which advertisement information is recorded are exchanged and, because a part of the low-priority area 2903 is not recorded, the recording data in the low-priority area 2903 is automatically reduced so that it fits in the recordable area.

### Other Embodiments

Although the present invention has been described with reference to preferred embodiments, it is to be understood that various modifications and changes may be made to those described above.

For example, the recording formats shown in FIG. 13 and FIGS. 26-29, which are shown to illustrate the formats output in the embodiments, are applicable to any of the recording device 106 and the recording device 1400. Note that the paper width size detection unit must be provided in the recording devices 106 and 1400 to record data in the formats shown in FIGS. 28A-28B.

A recording medium is conveyed in the upper direction of recording data in the first embodiment to the third embodiment. So, if the recordable area size of a recording medium is smaller than the recording data size, the positions of the areas are rearranged so that a high-priority area is in the upper side of the recording data. However, the present invention is applicable not only when a recording medium is conveyed in the upper direction but also when the recording medium is conveyed in the lower direction of recording data. For example, when a recording medium is conveyed in the lower direction of the recording data in the first embodiment, the present invention can be implemented by rearranging the positions so that a high-priority area is in the lower side of the recording data.

Although an inkjet card recording device that uses a line recording head is used as an example in the embodiments described above, the present invention is not limited to this recording device. The present invention is applicable also to recording devices that have various recording modes and that use various recording medium types; for example, the present invention is applicable also to an inkjet recording device in which the recording head serially scans in the direction (main scan direction) orthogonal to the recording medium conveyance direction (sub scan direction), a thermal-transfer recording device that uses an inked ribbon, and a label recording device that records data on a continuous form (tag form, label form).

Although advantageously applicable to a high-speed, high-production recording device or a recording device for recording on a prepaid type recording medium, the present invention is also applicable to a wide range of other recording devices.

What is claimed is:

1. A recording method for recording an image on a recording medium, comprising the steps of:
acquiring a size of a recording area of a whole image on one page as a page size;
detecting a size of a recording medium as a recording medium size;
dividing the whole image on one page into a plurality of areas having respective priorities;
determining based on the page size and the recording medium size if the whole image fits on the recording medium; and
if it is determined that the whole image does not fit on the recording medium, performing at least one of rearranging a recording position of a high-priority area, changing a recording size of a low-priority area, and discarding a part of recording data of the low-priority area, to prevent any part of an image of the high-priority area from being lost.

2. The recording method according to claim 1 wherein the whole image on one page is divided into the plurality of areas, high priority is assigned to a particular area and, if it is determined before recording the one page that a part of recording data in the high-priority area will be lost, a part of recording data of the low-priority area is discarded for recording to prevent any part of recording data of the high-priority area from being lost.

3. The recording method according to claim 1 wherein the whole image on one page is divided into the plurality of areas, high priority is assigned to a particular area and, if it is determined before recording the one page that a part of recording data in the high-priority area will be lost, the high-priority area is exchanged with the low-priority area for recording to prevent any part of recording data of the high-priority area from being lost.

4. The recording method according to claim 1 wherein the whole image on one page is divided into the plurality of areas, high priority is assigned to a particular area and, if it is determined before recording the one page that a part of recording data in the high-priority area will be lost, the recording data of the low-priority area is reduced in size for recording to prevent any part of recording data of the high-priority area from being lost.

5. The recording method according to claim 1 wherein a recordable size is calculated by subtracting a margin size from information on the detected recording medium size and the recordable size and a recording data size are compared with each other to determine if the whole image fits on the recording medium.

6. A recording device for recording an image on a recording medium, comprising:
a page size acquisition unit that acquires a size of a recording area of a whole image on one page as a page size;
a recording medium size detection unit that detects a size of a recording medium as a recording medium size;
an area division unit that divides the whole image on one page into a plurality of areas having respective priorities; and
a recording unit that determines if the whole image fits on the recording medium based on the page size and the recording medium size and, if it is determined that the whole image does not fit on the recording medium, performs at least one of rearranging a recording position of a high-priority area, changing a recording size of a low-priority area, and discarding a part of recording data of the low-priority area, to prevent any part of an image of the high-priority area from being lost.

7. The recording device according to claim 6, further comprising:
a priority assignment unit that assigns priority to each of the areas divided by said area division unit; and
a confirmation unit that confirms if all recording data on one page can be recorded without loss of data based on information on the recording medium size detected by said recording medium size detection unit wherein
if it is confirmed by said confirmation unit that the recording data will be recorded with a part thereof lost, said recording unit discards a part of recording data of the low-priority area for recording based on the priority of each area assigned by said priority assignment unit to prevent any part of recording data of the high-priority area from being lost.

8. The recording device according to claim 6, further comprising:
a priority assignment unit that assigns priority to each of the areas divided by said area division unit; and
a confirmation unit that confirms if all recording data on one page can be recorded without loss of data based on information on the recording medium size detected by said recording medium size detection unit wherein
if it is confirmed by said confirmation unit that the recording data will be recorded with a part thereof lost, said recording unit exchanges the high-priority area with the low-priority area for recording based on the priority of each area assigned by said priority assignment unit to prevent any part of recording data of the high-priority area from being lost.

9. The recording device according to claim 6, further comprising:
a priority assignment unit that assigns priority to each of the areas divided by said area division unit; and
a confirmation unit that confirms if all recording data on one page can be recorded without loss of data based on information on the recording medium size detected by said recording medium size detection unit wherein
if it is confirmed by said confirmation unit that the recording data will be recorded with a part thereof lost, said recording unit reduces a size of recording data of the low-priority area before recording based on the priority of each area assigned by said priority assignment unit to prevent any part of recording data of the high-priority area from being lost.

10. The recording device according to claim 7 wherein said recording medium size detection unit detects the recording medium size based on an output signal from a sensor installed on said recording device.

11. The recording device according to claim 8 wherein said recording medium size detection unit detects the recording medium size based on an output signal from a sensor installed on said recording device.

12. The recording device according to claim 9 wherein said recording medium size detection unit detects the recording medium size based on an output signal from a sensor installed on said recording device.

13. The recording device according to claim 7 wherein said confirmation unit calculates a recordable size by subtracting a margin size from information on the recording medium size detected by said recording medium size detection unit and compares the recordable size with a recording data size for confirmation.

14. The recording device according to claim 8 wherein said confirmation unit calculates a recordable size by subtracting a margin size from information on the recording medium size detected by said recording medium size detection unit and compares the recordable size with a recording data size for confirmation.

15. The recording device according to claim 9 wherein said confirmation unit calculates a recordable size by subtracting a margin size from information on the recording medium size detected by said recording medium size detection unit and compares the recordable size with a recording data size for confirmation.

16. The recording device according to claim 7 wherein said area division unit divides the recording data into the plurality of areas arranged in a recording medium conveyance direction.

17. The recording device according to claim 8 wherein said area division unit divides the recording data into the plurality of areas arranged in a recording medium conveyance direction.

18. The recording device according to claim 9 wherein said area division unit divides the recording data into the plurality of areas arranged in a recording medium conveyance direction.

19. The recording device according to claim 7 wherein said recording unit rearranges a recording position of the high-priority area from a predetermined recording position to a top side of a recording medium conveyance direction for recording.

20. The recording device according to claim 7 wherein said area division unit divides the recording data into the plurality of areas arranged in a direction orthogonal to a recording medium conveyance direction.

21. The recording device according to claim 8 wherein said area division unit divides the recording data into the plurality of areas arranged in a direction orthogonal to a recording medium conveyance direction.

22. The recording device according to claim 9 wherein said area division unit divides the recording data into the plurality of areas arranged in a direction orthogonal to a recording medium conveyance direction.

23. The recording device according to claim 7 wherein said recording unit rearranges a recording position of the high-priority area from a predetermined recording position to a conveyance base side for recording in a direction orthogonal to a recording medium conveyance direction.

24. The recording device according to claim 8 wherein said recording unit rearranges a recording position of the high-priority area from a predetermined recording position to a conveyance base side for recording in a direction orthogonal to a recording medium conveyance direction.

25. The recording device according to claim 9 wherein said recording unit rearranges a recording position of the high-priority area from a predetermined recording position to a conveyance base side for recording in a direction orthogonal to a recording medium conveyance direction.
